(19) United States
(12) Patent Application Publication
(10) Pub. No.: US 2014/0174552 A1
(43) Pub. Date: Jun. 26, 2014

(54) SUBSEA PRESSURE REGULATOR

(71) Applicant: HYDRIL USA MANUFACTURING LLC, Houston, TX (US)

(72) Inventor: Ryan Cheaney Gustafson, Houston, TX (US)

(73) Assignee: Hydril USA Manufacturing LLC, Houston, TX (US)

(21) Appl. No.: 13/722,698

(22) Filed: Dec. 20, 2012

(51) Int. Cl. F16K 17/00

(52) U.S. Cl. CPC F16K 17/00
USPC 137/14; 137/81.2

(57) ABSTRACT

A pressure regulator includes a regulator body, and a piston slidably disposed in the regulator body, wherein an end of the piston extends axially beyond an end of the regulator body and is exposed to an external pressure. A method of regulating pressure includes providing a pressure regulator having a piston slidably disposed in a regulator body, wherein an end of the piston extends beyond an end of the regulator body and is exposed to an external pressure, applying external pressure on the end of the piston, and outputting a regulated working fluid pressure from the pressure regulator.

### BACKGROUND

1. Field of the Disclosure

Embodiments disclosed herein relate generally to pressure regulators. In particular, embodiments disclosed herein relate to pressure regulators tuned to external hydrostatic pressure.

2. Background Art

Drilling systems are often employed to access and extract oil, natural gas, and other subterranean resources from the earth. These drilling systems may be located onshore or offshore depending on the location of a desired resource. Further, such systems include a wide array of components, such as valves, that control drilling or extraction operations. Often, some of these components are controlled through pressure variation, such as that provided by a hydraulic control system.

In some such systems, a hydraulic pressure regulator may be used to provide a fluid at a regulated working fluid pressure to downstream components, such as solenoid valves. One common type of hydraulic pressure regulator has a control piston that moves back and forth to open and close both supply ports and vent ports of the regulator in response to the magnitude of pressure within the regulator. As the functionality of an entire drilling system may depend on proper operation of the hydraulic pressure regulator, it is generally desirable to employ a pressure regulator that is both durable and sensitive to pressure changes. In addition, a subsea pressure regulator that provides a constant pressure output may be beneficial. At greater subsea depths, control of a pressure regulator may become more difficult to maintain.

### SUMMARY OF THE DISCLOSURE

In one aspect, embodiments disclosed herein relate to a pressure regulator including a regulator body, a piston slidably disposed in the regulator body, wherein an end of the piston extends axially beyond an end of the regulator body and is exposed to an external pressure.

In another aspect, embodiments disclosed herein relate to a method of regulating pressure, the method including providing a pressure regulator having a piston slidably disposed in a regulator body, wherein an end of the piston extends beyond an end of the regulator body and is exposed to an external pressure, applying external pressure on the end of the piston, and outputting a regulated working fluid pressure from the pressure regulator.

Other aspects and advantages of the invention will be apparent from the following description and the appended claims.

### BRIEF DESCRIPTION OF DRAWINGS

FIG. 1 shows a cross-section view of a pressure regulator in accordance with one or more embodiments of the present disclosure.

### DETAILED DESCRIPTION

The following is directed to various exemplary embodiments of the disclosure. The embodiments disclosed should not be interpreted, or otherwise used, as limiting the scope of the disclosure, including the claims. In addition, those having ordinary skill in the art will appreciate that the following description has broad application, and the discussion of any embodiment is meant only to be exemplary of that embodiment, and not intended to suggest that the scope of the disclosure, including the claims, is limited to that embodiment.

In one aspect, embodiments disclosed herein relate to a subsea pressure regulator adjustable in relation to external hydrostatic pressure. In particular, a regulated working fluid pressure of the subsea pressure regulator may be reduced with increasing subsea hydrostatic pressure (i.e., as water depth increases).

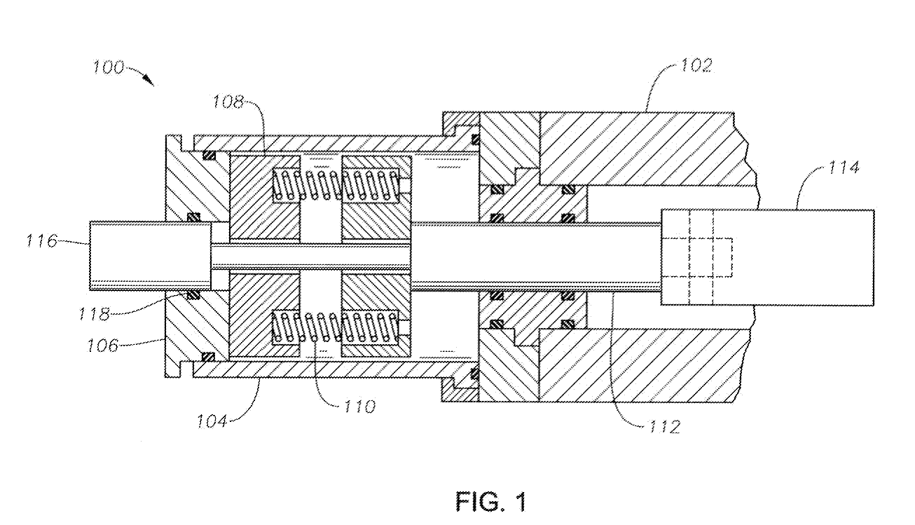

Referring to FIG. 1, a cross-section view of a pressure regulator 100 in accordance with one or more embodiments of the present disclosure is shown. The pressure regulator 100 includes a regulator body 102 coupled with a spring housing 104. The regulator body 102 may be coupled with the spring housing 104 using mechanical fasteners (not shown) or other known fastener devices. A piston 112 is slidably disposed within the regulator body 102 and spring housing 104. The piston 112 has a regulator slide 114 on an end within the regulator body 102 which controls a regulated working fluid pressure from the pressure regulator. As fluid enters the pressure regulator at a high inlet pressure, the regulator slide 114 is positioned to reduce the higher inlet pressure to a more manageable or desired regulated working fluid pressure, which is then output from the pressure regulator to one or more downstream components (e.g., valves).

The spring housing 104 includes spring guides 108 and springs 110 within the spring housing 104, which are used to bias the piston 112 into a first position. On a distal end of the spring housing 104, an adjustment end cap 106 is installed which may be used to adjust compression of the springs 110 (i.e., to provide more or less biasing force from the springs in a particular direction). An end 116 of the piston 112 extends beyond the distal end of the spring housing 104 and through the adjustable end cap 106, where it is exposed to an external environment outside the pressure regulator 100. Seals 118 between the end 116 of the piston 112 and the adjustable end cap 106 prevent fluid from entering the spring housing 104. The seals 118 may be elastomeric O-ring seals or other seals known to one of ordinary skill in the art. The seals 118 may be high-pressure rated seals to withstand increasing water depths up to 10,000 feet, or more.

The pressure regulator 100 described in accordance with one or more embodiments disclosed herein is configured to reduce regulated working fluid pressure with increasing water depth. The end 116 of the piston 112 that is exposed to an external environment will be, when the pressure regulator 100 is submerged subsea, exposed to an external hydrostatic pressure at a particular water depth. As the water depth increases, the external hydrostatic pressure acting on end 116 of the piston 112 likewise increases. The higher external hydrostatic pressure urges the piston 112 in a direction which reduces the regulated working fluid pressure of the pressure regulator. In certain embodiments, a correlation may exist between a particular external hydrostatic pressure and the regulated working fluid pressure. For example, an external hydrostatic pressure of 10,000 psi may yield a regulated working fluid pressure.

In certain embodiments, the external hydrostatic pressure acting on end 116 of the piston may aid the spring housing in reducing the regulated working fluid pressure of the pressure regulator. In other embodiments, the spring housing may be removed and only the external hydrostatic pressure acting on end 116 of the piston 112 may be responsible for reducing the regulated working fluid pressure of the pressure regulator.

Removing the compensator, increasing external capacity of the spring housing and preventing a volume change in the spring housing will cause the regulator to decrease pressure with increasing subsea pressure. When used with a 1 atmospheric accumulator bottle to close a BOP, the working pressure of the BOP operator and the rated load of the ram blocks could be exceeded. This regulator would limit the force to working limits and still utilize subsea and accumulated pressures.

Advantageously, embodiments of the present disclosure provide a pressure regulator that reduces the regulated working fluid pressure using an external hydrostatic pressure at a particular water depth. This increases the flexibility of using the pressure regulator at various water depths and reduces the amount of components needed to regulate higher working fluid pressures. In addition, the pressure regulator may be used with a 1 atmospheric bottle subsea.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

What is claimed is:

1. A pressure regulator comprising:
a regulator body; and
a piston slidably disposed in the regulator body,
wherein an end of the piston extends axially beyond an end of the regulator body and is exposed to an external pressure.

2. The pressure regulator of claim 1, further comprising a spring housing coupled to the regulator body.

3. The pressure regulator of claim 2, further comprising a spring guide within the spring housing.

4. The pressure regulator of claim 1, further comprising an adjustable end cap in an end of the spring housing.

5. The pressure regulator of claim 4, further comprising a seal between an inner diameter of the adjustable end cap and the piston.

6. The pressure regulator of claim 1, wherein the external pressure is a subsea hydrostatic pressure.

7. A method of regulating pressure, the method comprising:
providing a pressure regulator having:
a piston slidably disposed in a regulator body, wherein an end of the piston extends beyond an end of the regulator body and is exposed to an external pressure;
applying external pressure on the end of the piston; and
outputting a regulated working fluid pressure from the pressure regulator.
